(19) United States
(12) Patent Application Publication
(10) Pub. No.: US 2026/0122549 A1
(43) Pub. Date: Apr. 30, 2026

(54) METHODS AND SYSTEMS FOR ROUTING VOICE CALL TRAFFIC

(71) Applicant: T-Mobile Innovations LLC, Overland Park, KS (US)

(72) Inventor: Hang Hoi YAU, Sammamish, WA (US)

(21) Appl. No.: 18/925,386

(22) Filed: Oct. 24, 2024

(51) Int. Cl. H04W 40/02; H04W 28/02

(52) U.S. Cl. CPC H04W 40/02; H04W 28/0268

(57) ABSTRACT

Systems, methods and devices are provided for receiving, by a mobile network operator (MNO) network, a call request from a wireless device, determining the call request originated outside of the MNO and, in response to the call request originating outside of the MNO, routing, by the wireless network, the call request through an established default bearer.

### TECHNICAL BACKGROUND

When an IP based call, such as through voice over LTE (VoLTE) or voice over new radio (VoRN), is placed through a network, a dedicated session is established for the voice call that ensures a minimum quality of service for the voice call. However, in situations where the call is placed through a network that is not the home network of a subscriber, extra costs may be passed to the subscriber to maintain that quality of service.

### OVERVIEW

Exemplary embodiments described herein include systems, methods, and processing nodes for routing voice call traffic. An exemplary method includes receiving, by a mobile network operator (MNO) network, a call request from a wireless device, determining the call request originated outside of the MNO and, in response to the call request originating outside of the MNO, routing the call request through an established default bearer.

Further exemplary embodiments include a system for routing voice call traffic. The system includes a mobile network operator (MNO) comprising at least one processor. The system additionally includes a computing device communicatively connected to the MNO, wherein the MNO is configured to receive a call request from the computing device, determine the call request originated outside the MNO and, in response to the call request originating outside of the MNO, route the call request through an established default bearer.

In yet a further exemplary embodiment, a non-transitory computer readable medium is provided. The non-transitory computer-readable medium stores instructions, when executed by a processor, configuring the processor to receive a call request from a wireless device, determine the call request originated outside a mobile network operator (MNO) network, and, in response to the call request originating outside of the MNO network, route the call request through an established default bearer.

### BRIEF DESCRIPTION OF THE DRAWINGS

FIG. 1 illustrates an exemplary system for transmitting a voice call in accordance with disclosed embodiments.

FIG. 2 IS A BLOCK DIAGRAM ILLUSTRATING AN EXEMPLARY SYSTEM FOR ROUTING voice call traffic.

FIG. 3 illustrates a decision flow for routing voice call traffic in accordance with disclosed embodiments.

FIG. 4 illustrates an exemplary method for routing voice call traffic in accordance with disclosed embodiments.

FIG. 5 illustrates an example of a processing node in accordance with aspects of this disclosure.

FIG. 6 illustrates an example of a computing device in accordance with aspects of this disclosure.

### DETAILED DESCRIPTION

When a voice over IP (VoIP) call is placed through a network which is not the home network, such as while roaming, the foreign network will take similar steps for establishing a dedicated session for the call that ensures quality of the voice call over that network. However, ensuring this quality for the call often comes at extra costs to the subscriber, which may quickly add up.

In exemplary embodiments, a network will utilize a default session for setting signaling rather than the more expensive dedicated session. Although this default session is a best effort communication, which does not guarantee priority for the voice call, the default session may still be used for transmitting the voice call without the quality guarantees of the dedicated session. In situations where cost savings is prioritized over the quality of the call, the default “best effort” session can be used for the call.

Exemplary embodiments described herein include methods and systems for routing an IP based voice call through a default session based on detecting that the call originated from outside of the network. For example, a subscriber places a call in a foreign country, when the call is detected to have being placed by a device that is registered at a network outside of the network being used for the call, the network may utilize a “best effort” default session, which is often used for lower priority uses such as web browsing, in order to avoid the costs of guaranteeing quality of service through a dedicated session. In examples, the call may switch from the default session to use a dedicated session, such as when the extra costs associated with the quality outweighs the low quality being provided through the default session.

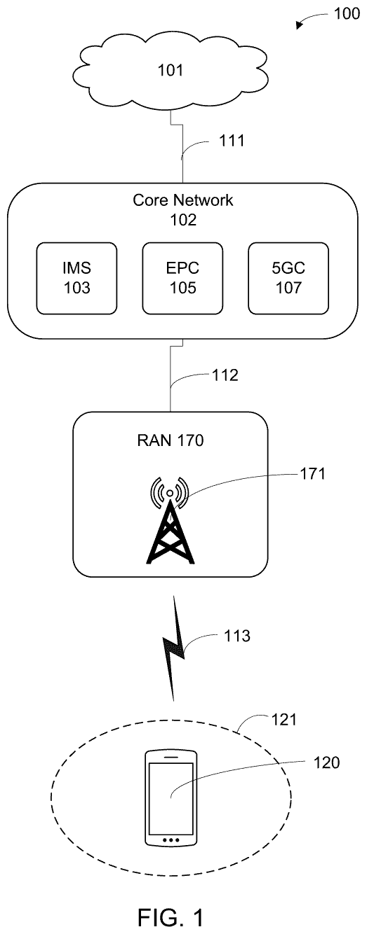

These and other examples will be described in greater detail below in relation to FIGS. 1-6.

FIG. 1 depicts an exemplary system 100 for voice call routing. System 100 includes a communication network 101, a core network 102 and a radio access network (RAN) 170, including at least one access node 171.

Core network 102 is connected to communication network 101 over communication link 111. Core network 102 includes an IP multimedia subsystem (IMS) 103. IMS 103 as used herein is a framework used for delivering IP multimedia services, such as voice over internet protocol (VoIP) and/or other similar services, across a network. IMS 103 may include a call session control function (CSCF). The CSCF 104 as used herein is a component of IMS 103 used for session control, signaling and routing in multimedia communication. In embodiments, the CSCF may be used for handling SIP communication. In embodiments, IMS 103 may be used for communication between entities or components of network 101 and wireless device 120. For example, the CSCF of the IMS 103 may be used for transmitting SIP communication to wireless device 120. IMS 103 may also include an application server (AS). For example, the AS may be used for formatting device data, such as biometric data, in a format that can be received by a receiving entity.

Core network 102 also includes an evolved packet core (EPC) 105 and a 5G core (5GC) 107. EPC 105 as used herein are core network components used for managing data for LTE, 4G, and/or other networks. In embodiments, EPC 105 may be used for establishing and managing packet data network (PDN) connections. 5GC 107 as used herein are core network components used for managing data for 5G networks. In embodiments, 5GC 107 may be used for establishing and managing packet data unit (PDU) sessions. It should be noted that core network 102 may include other components used for managing data for networks not described herein, such as a satellite core network.

The RAN 170 may include other devices and additional nodes not described herein. For example, RAN 170 may include devices used for routing a VoIP call from wireless device 120 to core network 102. RAN 170 is connected to core network 102 over communication link 112.

System 100 also includes a wireless device 120. In embodiments, system 100 may include multiple wireless devices. Wireless device 120 is configured to operate in one or more coverage areas 121. Wireless device 120 may be an end-user wireless device. Wireless device 120 may include any device configured to send and receive messages over SIP. Wireless device 120 may include any device configured to send and receive VoIP calls, such as voice over LTE (VoLTE) and voice over new radio (VoRN) calls. In embodiments, wireless device 120 communicates with RAN 170 over communication link 113. Examples of communication link 113 may include a 6G network link, 5G network link, 4G LTE network link, and the like.

Communication network 101 may be wired and/or wireless communication network. In embodiments, communication network 101 may include processing nodes, routers, gateways, physical and/or wireless data links for carrying data among various network elements, including combinations thereof. In embodiments, communication network 101 may include a local area network, a wide area network, an inter-network, such as the internet, and the like. Communication network 101 may be capable of carrying data, such as, for example, to support multimedia files, and data communications by wireless device 120. Wireless network protocols can include multimedia broadcast multicast service (MBMS), code division multiple access (CDMA) 1xRTT, Global System for Mobile communications (GSM), Universal Mobile Telecommunications System (UMTS), High-Speed Packet Access (HSPA), Evolution Data Optimized (EV-DO), EV-DO rev. A, Third Generation Partnership Project Long Term Evolution (3GPP LTE), Worldwide Interoperability for Microwave Access (WiMAX), Fourth Generation broadband cellular (4G, LTE Advanced, etc.), and Fifth Generation mobile network or wireless system (5G, 5G New Radio (“5G NR”), or 5G LTE), 6G, other terrestrial network protocols, and/or non-terrestrial network protocols. Wired network protocols that may be utilized by communication network 101 comprise Ethernet, Fast Ethernet, Gigabit Ethernet, Local Talk (such as Carrier Sense Multiple Access with Collision Avoidance), Token Ring, Fiber Distributed Data Interface (FDDI), Asynchronous Transfer Mode (ATM), and/or other protocols. Communication network 101 may also include additional base stations, controller nodes, telephony switches, internet routers, network gateways, computer systems, communication links, or some other type of communication equipment, and combinations thereof.

The core network 102 includes core network functions and elements. The core network 102 may may be structured using a service-based architecture (SBA). The network functions and elements may be separated into user plane functions and control plane functions. In an SBA architecture, service-based interfaces may be utilized between control-plane functions, while user-plane functions connect over point-to-point link. The user plane function (UPF) accesses a data network, such as network 101, and performs operations such as packet routing and forwarding, packet inspection, policy enforcement for the user plane, quality of service (QoS) handling, etc. The control plane functions may include, for example, a network slice selection function (NSSF), a network exposure function (NEF), a network repository function (NRF), a policy control function (PCF), a unified data management (UDM) function, an application function (AF), an access and mobility function (AMF), an authentication server function (AUSF), and a session management function (SMF). Additional or fewer control plane functions may also be included. The AMF receives connection and session related information from the wireless devices 120 and is responsible for handling connection and mobility management tasks. The SMF is primarily responsible for creating, updating, and removing sessions and managing session context. The UDM function provides services to other core functions, such as the AMF, SMF, and NEF. The UDM may function as a stateful message store, holding information in local memory. The NSSF can be used by the AMF to assist with the selection of network slice instances that will serve a particular device. Further, the NEF provides a mechanism for securely exposing services and features of the core network.

Although one core network 102 is shown, multiple core networks 102 may be utilized. Alternatively, the single core network 102 may include a distributed, cloud-native, converged core gateway. For example, the converged core gateway could connect EPC 105 to 5GC 107 network.

Communication links 111 and 112 can use various communication media, such as air, space, metal, optical fiber, or some other signal propagation path, including combinations thereof. Communication links 111 and 112 can be wired or wireless and use various communication protocols such as Internet, Internet protocol (IP), local-area network (LAN), S1, optical networking, hybrid fiber coax (HFC), telephony, T1, or some other communication format-including combinations, improvements, or variations thereof. Wireless communication links can be a radio frequency, microwave, infrared, or other similar signal, and can use a suitable communication protocol, for example, Global System for Mobile telecommunications (GSM), Code Division Multiple Access (CDMA), Worldwide Interoperability for Microwave Access (WiMAX), Long Term Evolution (LTE), 5G NR, 6G or combinations thereof. Other wireless protocols can also be used. Communication links 111 and 112 can be direct links or might include various equipment, intermediate components, systems, and networks, such as a cell site router, etc. Communication links 111 and 112 may comprise many different signals sharing the same link.

In embodiments, RAN 170 may include various access network systems and devices such as access node 171. The RAN 170 is disposed between the core network 102 and the end-user wireless devices 120. Components of the RAN 170 may communicate directly with the core network 102 and others may communicate directly with the end user wireless devices 120. The RAN 170 may provide services from the core networks 102 to the end-user wireless devices 120.

The RAN 170 includes at least an access node (or base station) 171 such as an eNodeB or gNodeB communicating with the plurality of end-user wireless devices 120. In embodiments, access node 171 includes a unique identifier. It is understood that the disclosed technology may also be applied to communication between an end-user wireless device and other network resources, such as relay nodes, controller nodes, antennas, etc. Further, multiple access nodes may be utilized. For example, some wireless devices may communicate with an LTE eNodeB and others may communicate with an NR gNodeB.

Access node 171 can be, for example, standard access nodes such as a macro-cell access node, a base transceiver station, a radio base station, an eNodeB device, an enhanced eNodeB device, a gNodeB in 5G NR, or the like. The gNBs may include, for example, centralized units (CUs) and distributed units (DUs).

In additional embodiments, access nodes may comprise two co-located cells, or antenna/transceiver combinations that are mounted on the same structure. Alternatively, access node 171 may comprise a short range, low power, small-cell access node such as a microcell access node, a picocell access node, a femtocell access node, or a home eNodeB device. As will be further described below, functionality for providing a default bearer for calls originating outside of an MNO network may be included within the access nodes. Access node 171 can be configured to deploy one or more different carriers, utilizing one or more RATs. For example, a gNodeB may support NR and an eNodeB may provide LTE coverage. It would be evident to one of ordinary skill in the art, in light of this disclosure, the many other combinations of access nodes and carriers that could be deployed.

The access nodes 171 may include a processor and associated circuitry to execute or direct the execution of computer-readable instructions to perform operations such as those further described herein. Access nodes can retrieve and execute software from storage, which can include a disk drive, a flash drive, memory circuitry, or some other memory device, and which can be local or remotely accessible. The software comprises computer programs, firmware, or some other form of machine-readable instructions, and may include an operating system, utilities, drivers, network interfaces, applications, or some other type of software, including combinations thereof.

The wireless devices 120 may include any wireless device included in a wireless network. For example, the term “wireless device” may include a relay node, which may communicate with an access node. The term “wireless device” may also include an end-user wireless device, which may communicate with the access node 171 through the relay node. The term “wireless device” may further include an end-user wireless device that communicates with the access node 171 directly without being relayed by a relay node.

Wireless devices 120 may be any device, system, combination of devices, or other such communication platform capable of communicating wirelessly with access network 171 using one or more frequency bands and wireless carriers deployed therefrom. Each of wireless devices 120, may be, for example, a mobile phone, a wireless phone, a wireless modem, a personal digital assistant (PDA), a VoIP phone, a voice over packet (VOP) phone, or a soft phone, an internet of things (IoT) device, as well as other types of devices or systems that can send and receive audio or data. The wireless devices 120 may be or include high power wireless devices or standard power wireless devices. Other types of communication platforms are possible.

System 100 may further include many components not specifically shown in FIG. 1 including processing nodes, controller nodes, routers, gateways, and physical and/or wireless data links for communicating signals among various network elements. System 100 may include one or more of a local area network, a wide area network, and an internetwork, such as the internet. System 100 may be capable of communicating signals and carrying data, for example, to support voice, push-to-talk, broadcast video, and data communications by end-user wireless devices 120. System 100 may include additional base stations, controller nodes, telephony switches, internet routers, network gateways, computer systems, communication links, or other type of communication equipment, and combinations thereof.

Other network elements may be present in system 100 to facilitate communication but are omitted for clarity, such as base stations, base station controllers, mobile switching centers, dispatch application processors, and location registers such as a home location register or visitor location register. Furthermore, other network elements that are omitted for clarity may be present to facilitate communication, such as additional processing nodes, routers, gateways, and physical and/or wireless data links for carrying data among the various network elements, e.g. between the RAN 170 and the core network 102.

The methods, systems, devices, networks, access nodes, and equipment described herein may be implemented with, contain, or be executed by one or more computer systems and/or processing nodes. The methods described above may also be stored on a non-transitory computer readable medium. Many of the elements of system 100 may be, comprise, or include computers systems and/or processing nodes, including access nodes, controller nodes, and gateway nodes described herein.

The operations for routing voice call transmission may be implemented as computer-readable instructions or methods, and processing nodes on the network and/or computing device, such as end user wireless device, for executing the instructions or methods. The processing node may include a processor included in the access node or a processor included in any controller node in the wireless network that is coupled to the access node. The computing device may include at least a processor and a memory with instructions configuring the processor to execute instructions.

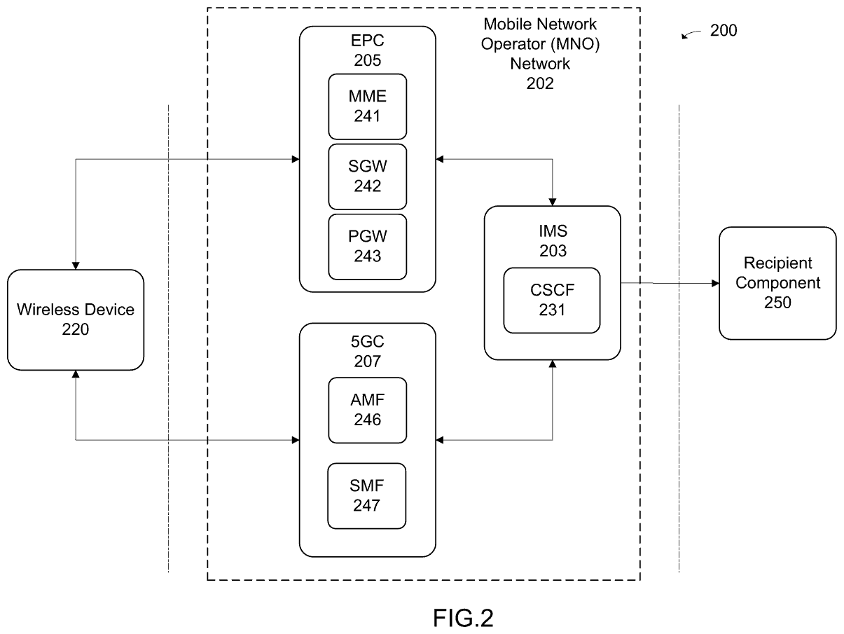

Now referring to FIG. 2, an exemplary system 200 for routing voice call is presented. System 200 includes a wireless device 220. Wireless device 220 may be the same as wireless device 120. System 200 also includes a mobile network operator (MNO) network 202. An MNO is an entity that provides cellular wireless communications to subscribing wireless devices. MNO network 202 may include a RAN, core network and/or a communication network, which may be the same as, respectively, RAN 170, core network 102 and communication network 101. MNO network 202 includes services and components used by a wireless network for handling voice and data transmissions. MNO network 202 includes IMS 203, EPC 205 and 5GC 207. IMS 203, EPC 205 and 5GC 207 may be the same as IMS 103, EPC 105 and 5GC 107, respectively.

System 200 also includes a recipient component 250. As used herein, a recipient component 250 may include any computing device or component that is capable of receiving IMS traffic, such as signaling and voice transmission. In embodiments, recipient component 250 may be similar to wireless device 220. For example, both wireless device 220 and recipient component 250 may be smartphones.

In embodiments, IMS 203 includes a call session control function (CSCF) 231. CSCF 231 as used herein is a component of IMS 203 used for session control, signaling and routing in multimedia communication. In embodiments, CSCF 231 is used for handling SIP communication. For example, CSCF 231 may handle establishing the PDN default bearer session with wireless device 220 through EPC 205 or 5GC 207.

In embodiments, EPC 205 includes a mobility management entity (MME) 241, while 5GC 207 includes an access and mobility management function (AMF) 246.

In instances, wireless device 220 attempts to attach to the MNO network 202. For example, wireless device 220 may transmit an attach request or allocation update to the MNO network 202. With the attachment attempt transmission, the wireless device 220 transmits a device identifier, such as an international mobile subscriber identity (IMSI). In instances, MNO network 202 may use MME 241, for an LTE connection, or AMF 246, for 5G connection, to detect whether the mobile country code (MMC) and mobile network code (MNC) included in the IMSI transmitted corresponds to an out-of-country network. In instances, MME 241 or AMF 246 retrieves a default data network name (DNN) for the wireless device 220.

In embodiments, EPC 205 also includes a serving gateway (SGW) 242 and a packet gateway (PGW) 243. In embodiments, 5GC includes a session management function (SMF) 247.

Based on detecting the out-of-country or out of the MNO network status of the wireless device 220, CSCF 231 routes communication through the PDN or PDU default bearers. In instances, default DNN is used for routing the communication through the PDN or PDU default bearers. In embodiments, the out-of-country status may be a roaming state. For example, upon detecting that the wireless device 220 is roaming, the CSCF 231 routes the IMS signals and the voice or video call through the PDN or PDU default bearers. It should be noted that unlike other connections where at this stage a dedicated bearer for the voice or video call, in this example system the voice/video call is also routed through the default session without a guaranteed bit rate (GBR) or of quality of service (QoS) included with a setting a dedicated bearer.

In some embodiments, a dedicated bearer may later be established based on a subscriber request from the wireless device 220. For example, the wireless device 220 may later establish a dedicated bearer for IMS media payload, which may include a GBR and other QoS for the call. In embodiments, establishing the dedicated bearer includes using an IMS DNN. As a connection through a default bearer is a “best effort” connection, if better call quality is desired, additional fees may be applied to the subscribing wireless device (e.g., paid to the MNO for providing enhanced service to the subscriber wireless device) to provide a GBR.

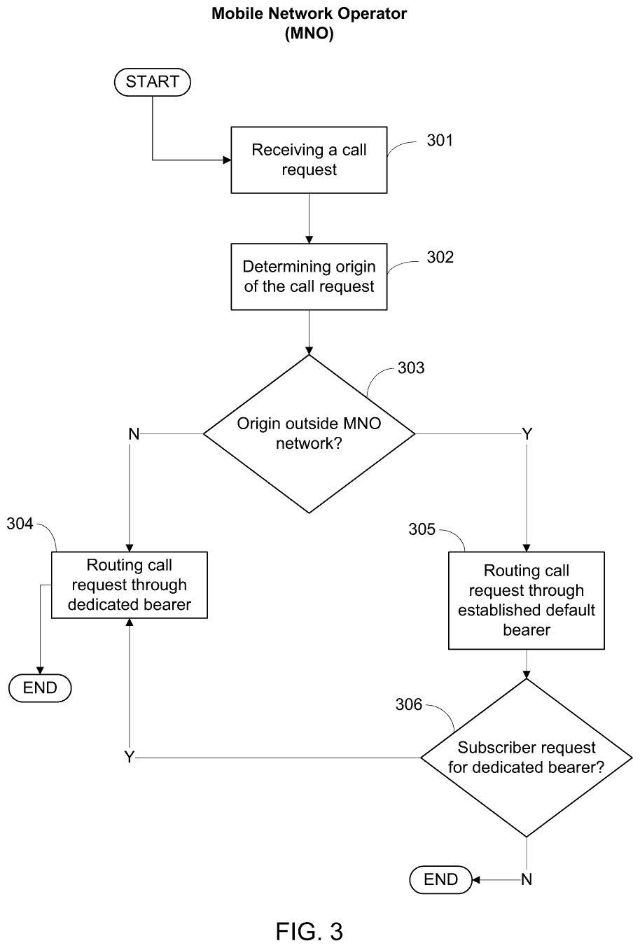

Now referring to FIG. 3, an example decision flow 300 is presented. In this example, the flow begins, at step 301, by a mobile network operator (MNO) network, receiving a call request. As noted above, in embodiments, the call request may be a VoIP call request, such as VoLTE or VoNR request. In examples, the call request may originate within the MNO network 202 or may originate on a roaming network other than the MNO network 202. In instances, the call request may be received from a wireless device, such as wireless device 120 or wireless device 220.

The flow continues at step 302 by the MNO network determining the origin of the call request. For example, as described above, the MNO network may determine the origin using a wireless device identifier of the wireless device, such as an IMSI.

At step 303, if the origin of the call request is within the MNO network, at step 304, the flow continues by routing the call request through an IMS dedicated bearer, by the MNO network, using an IMS DNN for the wireless device. In instances, call request may still be considered to be inside the MNO network if the network code of the call request is different from the network code of the MNO, but it has the same country code, i.e., the country code of the call request indicates a country that is the home operating territory or in the home operating territory of the MNO. For example, the device's mobile country code (MMC) may be the same as the MNO network, but the mobile network code (MNC) differs from the MNO network. In embodiments, the dedicated bearer includes a GBR.

If the call request origin is outside the MNO network (e.g., at a roaming network), then at step 305, the flow includes routing the call request through an established default bearer rather than providing a dedicated bearer with a GBR. In instances, the default bearer is established using a default DNN, such as described in reference to FIG. 2. As noted above, routing the call request through the established default bearer includes using CSCF 231. As described in reference to FIG. 2, the established default bearer may be a packet data network or packet data unit proving end-to-end user plane connectivity between the wireless device and a data network. In instances, the established default bearer may provide a lower data throughput, e.g., data bit rate, than the dedicated bearer during at least one time period of default bearer usage.

After routing the call request through the established default bearer, if there is a subscriber request for a dedicated bearer from the wireless device at step 306, then the flow proceeds to step 304 by routing the call request through an IMS dedicated bearer. Otherwise, the call request continues to be routed through the established default bearer.

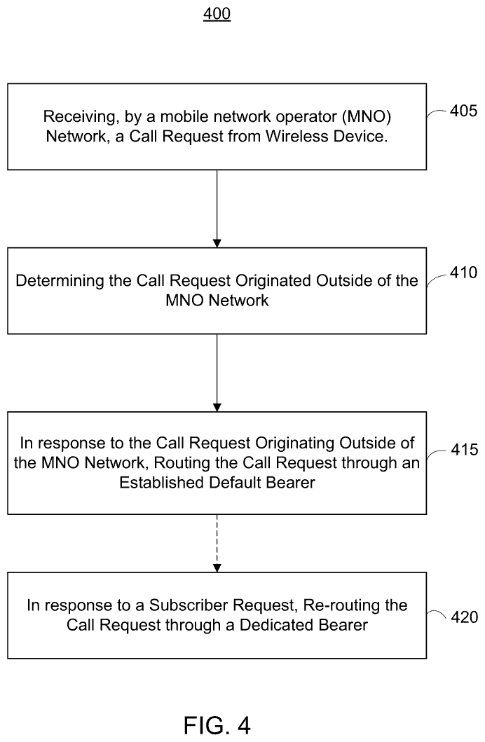

Now referring to FIG. 4, an example flow diagram of a method 400 for routing voice call transmission. The method 400 includes, at step 405, receiving, by an MNO network, a call request from a wireless device.

At step 410, method 400 includes determining the call request originated from outside of the MNO network. In embodiments, the call request may be a VoLTE or a VoNR communication. In embodiments, the call request may have originated on a roaming network.

The method 400 includes at step 415, in response to the call request originating outside of the MNO network, routing the call request through an established default bearer. In embodiments, the established default bearer may be a packet data network (PDN), or a packet data unit (PDU), providing end-to-end user plane connectivity between the wireless device and a data network. In embodiments, the established default bearer may not have a guaranteed bit rate (GBR). In embodiments, routing the call request may include using a call session control function (CSCF), which may include CSCF 231.

In embodiments, the method 400 may include, at step 420, in response to a subscriber request, re-routing the call request through a dedicated bearer. In embodiments, the dedicated bearer may have a GBR. In instances, the established default bearer may provide a lower data throughput, e.g., data bit rate, than the dedicated bearer during at least one time period of default bearer usage for a call corresponding to the call request.

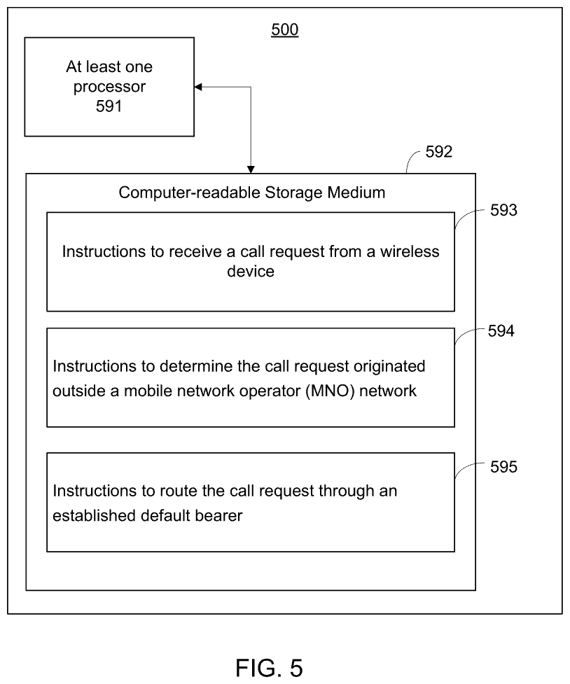

Now referring to FIG. 5, an example computing device 500 is presented. In this example, computing device 500 includes at least one processor 591 communicably coupled to a computer-readable storage medium 592. The at least one processor 591 may include a microprocessor, a microcontroller, one or more central processing unit (CPU) cores, an application-specific integrated circuit (ASIC), one or more graphical processing unit (GPU) cores, a field programmable gate array (FPGA), and/or any other hardware device suitable for retrieval and execution of instructions from computer-readable storage medium 592. In instances, at least one processor 591 may include electronic circuitry for performing instructions described in this disclosure.

In instances, computer-readable storage medium 592 may be any medium suitable for storing executable instructions. In examples, without limitation, computer-readable storage medium 592 may include read-only memory (ROM), random-access memory (RAM), erasable electrically programmable ROM (EEPROM), Solid State Drive (SSD), optical disc, and the like. Computer-readable medium storage 592 may be disposed within computing device 500. In embodiments, computer-readable storage medium 592 may be external, and communicably connected, to computing device 500. The instruction stored on computer-readable storage medium may be used to implement method steps described in reference to FIG. 4.

In this example, computer-readable storage medium 592 is encoded with set of instructions 593, 594 and 595. In embodiments, executable instructions included in each block may be included in different blocks shown and blocks not shown.

Instruction 593, when executed by at least one processor 591, configures the at least one processor 591 to receive a call request from a wireless device. The wireless device may include wireless device 120 and 220 described, respectively, in reference to FIGS. 1 and 2.

Instruction 594, when executed by at least one processor 591, configures the at least one processor 591 to determine the call request originated outside a mobile network operator (MNO) network. The MNO network may be consistent with, or include, network components described in reference to FIGS. 1 and 2, such as MNO network 202.

In some embodiments, instruction 595, when executed by at least one processor 591, configures the at least one processor 591 to route the call request through an established default bearer. In embodiments, computer-readable storage medium 592 may include instructions configuring the at least one processor 591 to re-route the call request through a dedicated bearer based on a subscriber request. In embodiments, the request is originated on a roaming network, wherein the call request is routed through the established default bearer rather than a dedicated bearer.

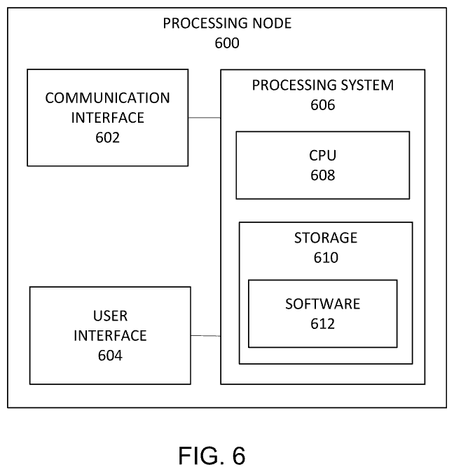

Now referring to FIG. 6, an example processing node 600, which may be configured to perform the methods and operations disclosed herein providing a default bearer for calls originating outside of an MNO network. The processing node 600 includes a communication interface 602, user interface 604, and processing system 606 in communication with communication interface 602 and user interface 604. Communication interface 602 may include hardware components, such as network communication ports, devices, routers, wires, antenna, transceivers, etc.

User interface 604 may include hardware components, such as touch screens, buttons, displays, speakers, etc.

Processing system 606 includes a central processing unit (CPU) or processor 608 and storage 610. Storage 610 may include a disk drive, flash drive, memory circuitry, or other memory device including, for example, a buffer. Storage 610 can store software 612 which is used in the operation of the processing node 600. Software 612 may include computer programs, firmware, or some other form of machine-readable instructions, including an operating system, utilities, drivers, network interfaces, applications, or some other type of software. Processing system 606 may include a processor 608 and other circuitry to retrieve and execute software 612 from storage 610, which may be internal or external to the processing system 606. Processing node 600 may further include other components such as a power management unit, a control interface unit, etc., which are omitted for clarity. Communication interface 602 permits processing node 600 to communicate with other network elements. User interface 604 permits the configuration and control of the operation of processing node 600. Processing node 600 may be included in various elements of the wireless network including an access node, proxy call session control function (P-CSCF), emergency call session control function (E-CSCF), gateway mobile location center (GMLC), secure telephone identity authentication service (STI-AS), session border controller (SBC), and the like. In this example, software 612 may include the instructions described in reference to FIG. 5.

The exemplary systems and methods described herein may be performed under the control of a processing system executing computer-readable codes embodied on a computer-readable recording medium or communication signals transmitted through a transitory medium. The computer-readable recording medium may be any data storage device that can store data readable by a processing system, and may include both volatile and nonvolatile media, removable and non-removable media, and media readable by a database, a computer, and various other network devices. Examples of the computer-readable recording medium include, but are not limited to, read-only memory (ROM), random-access memory (RAM), erasable electrically programmable ROM (EEPROM), flash memory or other memory technology, holographic media or other optical disc storage, magnetic storage including magnetic tape and magnetic disk, and solid-state storage devices. The computer-readable recording medium may also be distributed over network-coupled computer systems so that the computer-readable code is stored and executed in a distributed fashion. The communication signals transmitted through a transitory medium may include, for example, modulated signals transmitted through wired or wireless transmission paths.

The above description and associated figures teach the best mode of the invention. The following claims specify the scope of the invention. Note that some aspects of the best mode may not all be within the scope of the invention as specified by the claims. Those skilled in the art will appreciate that the features described above can be combined in various ways to form multiple variations of the invention. As a result, the invention is not limited to the specific embodiments described above, but only by the following claims and their equivalents.

What is claimed is:

1. A method, the method comprising:
receiving, by a mobile network operator (MNO) network, a call request from a wireless device;
determining the call request originated outside of the MNO; and
in response to the call request originating outside of the MNO, routing, by the MNO network, the call request through an established default bearer.

2. The method of claim 1, wherein the call request originated on a roaming network.

3. The method of claim 2, wherein the call request is routed through the established default bearer rather than a dedicated bearer.

4. The method of claim 3, wherein the dedicated bearer has a guaranteed bit rate (GBR).

5. The method of claim 1, further comprising re-routing the call request through a dedicated bearer based on a subscriber request.

6. The method of claim 1, wherein the routing through the established default bearer comprises using a call session control function (CSCF).

7. The method of claim 1, wherein the call request is for a voice over LTE (VoLTE) communication.

8. The method of claim 1, wherein the call request is for a voice over New Radio (VoNR) communication.

9. The method of claim 1, wherein the established default bearer does not have a GBR.

10. The method of claim 1, wherein the established default bearer is a packet data network (PDN)/packet data unit (PDU) providing end-to-end user plane connectivity between the wireless device and a data network.

11. A system, the system comprising:
a mobile network operator (MNO) comprising at least one processor;
a computing device communicatively connected to the MNO, wherein the MNO configured to:
receive a call request from the computing device;
determine the call request originated outside the MNO; and
in response to the call request originating outside of the MNO, route the call request through an established default bearer.

12. The system of claim 11, wherein the call request originated on a roaming network.

13. The system of claim 12, wherein the call request is routed through the established default bearer rather than a dedicated bearer.

14. The system of claim 13, wherein the dedicated bearer has a guaranteed bit rate (GBR).

15. The system of claim 11, wherein the MNO is further configured to re-route the call request through a dedicated bearer based on a subscriber request.

16. The system of claim 11, wherein the MNO is further configured to route the call request through the established default bearer using a call session control function (CSCF).

17. The system of claim 11, wherein the established default bearer is a packet data network (PDN)/packet data unit (PDU) providing end-to-end user plane connectivity between the computing device and a data network.

18. The system of claim 11, wherein the established default bearer does not have a GBR.

19. A non-transitory computer-readable medium storing instructions, when executed by at least one processor, configuring the at least one processor to:
receive a call request from a wireless device;
determine the call request originated outside a mobile network operator (MNO) network; and
in response to the call request originating outside of the MNO, route the call request through an established default bearer.

20. The non-transitory computer-readable medium storing instructions of claim 19, wherein the call request originated on a roaming network and wherein the call request is routed through the established default bearer rather than a dedicated bearer.
